(19) United States
(12) Patent Application Publication
(10) Pub. No.: US 2009/0187496 A1
(43) Pub. Date: Jul. 23, 2009

(54) DATA WORKBENCH FOR ACCOUNTING DATA MANAGEMENT

(76) Inventor: Corey D. Edens, Scottsdale, AZ (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/016,344

(22) Filed: Jan. 18, 2008

(51) Int. Cl. G06Q 10/00

(52) U.S. Cl. 705/30

(57) ABSTRACT

Methods and apparatuses enable management of accounting data for currency exposure analysis. A management system receives general ledger data defining asset and liability accounts balances for a business entity. The management system selectively filters the account balances based on functional currency and whether they are subject to revaluation. The management system can thus provide a data set of data that can properly be evaluated for currency exposure risk. The management system generates one or more reports to indicate what errors or potential errors, if any, exist within the data. The management system may be configured to apply additional filters to the data and/or provide additional processing to prepare the data for passing to a foreign exchange risk analysis module.

### FIELD

Embodiments of the invention relate to data aggregation and management, and more particularly to accounting data management tools that provide an analytic framework to assess foreign currency accounting data from a single or multiple ERP/accounting systems and to create foreign currency exposure data sets by applying a series of filters to the accounting data aggregated from these systems.

### BACKGROUND

Companies record business transactions in their accounting systems each and every business day, including a sale of their product, a purchase of materials or services, accruals and adjustments. As companies expand internationally, they introduce new business requirements associated with proper multicurrency accounting. The accounting systems need to be able to handle the distinctions between transaction currency, local currency, functional currency and reporting currency and the people recording the underlying business transactions need to be trained properly and understand how multicurrency transactions should be recorded.

The base assumption for valid foreign currency exposure data is that the underlying multicurrency accounting entry has been recorded properly in transaction currency in the multicurrency accounting system. Accounting controls should be maintained and periodically tested to assure that the entries are being recorded properly. The resulting account balances should be reconciled and analytic review performed in the transaction currency. This provides additional assurance.

Issues with accounting system configurations and breakdowns in underlying processes and/or accounting controls can lead to the improper recording of multicurrency transactions. Examples include 1) the entry of a transaction in the local currency of the owing entity instead of the currency of the invoice or 2) clearing/settlement of open items or account balances in local currency instead of the transaction currency. In the first case, the transaction currency balance is not visible, can not be properly managed if it represents foreign currency exposure and results in a lump sum realized foreign currency gain or loss when the item or balance is settled or cleared. The second case results in invalid transaction currency—local currency data relationships within the multicurrency accounting system. Because monetary asset and liability account revaluation under FAS 52 is dependent on valid transaction currency balances, invalid balances can lead to incorrect unrealized foreign currency gain/loss calculations and results posted to the company's income statement when account revaluation occurs during period-end processing.

Effective foreign currency risk management is based upon 1) valid multicurrency accounting data and 2) the ability to extract the correct subset of the data representing foreign currency exposure to the company. Depending upon the size and complexity of the company, the multicurrency accounting data can reside within one or many source accounting systems. Companies need the ability to aggregate multicurrency accounting data for a given date from a number of underlying source systems. This will provide visibility and transparency into the complete set of multicurrency accounting records, allowing various levels of data analysis focused on testing the validity of the underlying data and the data relationships necessary for effective period-end account revaluation under FAS 52.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram of an embodiment of an accounting data management tool for foreign currency exposure data.

FIG. 2 is a block diagram of an embodiment of a filter engine.

FIGS. 3A-3C are block diagrams of embodiments of user interfaces for interacting with the accounting data management tool for foreign currency exposure data.

FIGS. 4A-4D are block diagram representations of an embodiment of accounting data management for foreign currency exposure data.

FIG. 5 is a flow diagram of an embodiment of a process for managing foreign currency exposure accounting data.

Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

### DETAILED DESCRIPTION

Given a set of multicurrency accounting data, companies need the ability to extract a subset representing foreign currency exposure. This can be accomplished by subjecting the set of multicurrency accounting data to a series of defined filters such as a functional currency filter, a revaluation rule filter and an exclusion filter, based upon specific data elements within the transaction currency data record. This filtered subset of multicurrency accounting data is then available for use in determining and managing the resultant risk due to currency exposure.

As provided herein, data management tools enable a company to obtain the correct data for currency exposure analysis from general ledger data. It is the experience of the inventors that companies large to small have inaccuracies in the data they use for currency exposure risk analysis and/or errors in the processes used to analyze currency risk. The companies are not aware of the inaccuracies. Thus, generally there can be no assumption made as to the validity of data used for currency risk analysis. As provided herein, the currency exposure data management tools enable analysis and verification of the accounting data and the processes applied for currency risk analysis by a company. Thus, the “correct” accounting data can be gathered and assessed, which provides an accurate currency risk analysis. Generally, the currency exposure data management tools as described below receive general ledger data and selectively filter the data with a set of hierarchical rules and/or processes. The currency exposure data management tools filter data based on the functional currency of the entities represented within the application, whether or not accounts represented by the data are subject to periodic revaluation and whether specific data elements should be excluded given specific data element criteria.

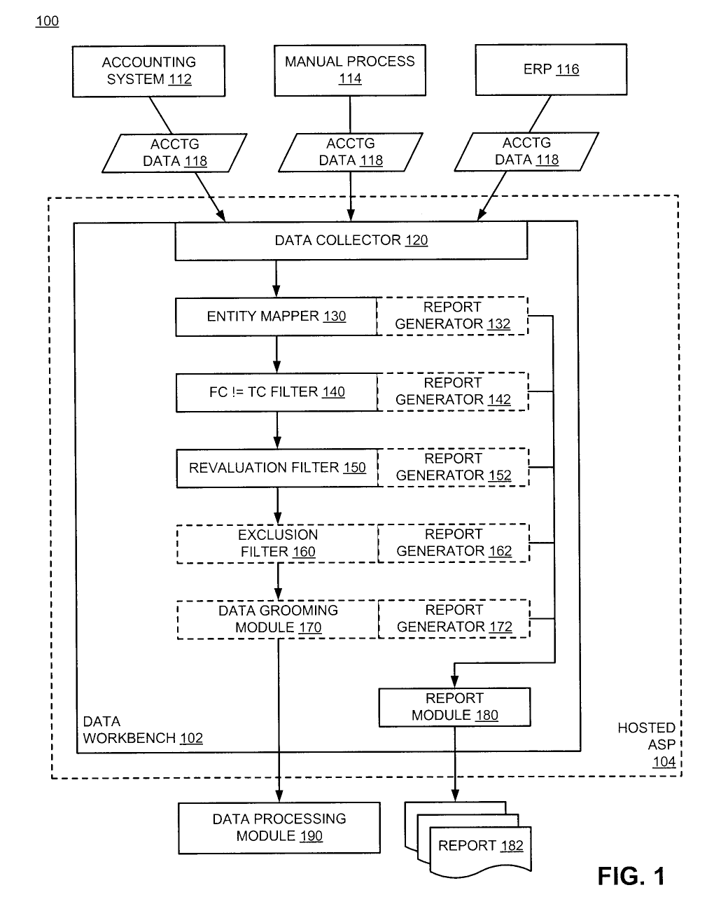

FIG. 1 is a block diagram of an embodiment of a currency exposure data management tool. System 100 represents a currency exposure data management system, which will receive input accounting data, and output data for further analysis or action. System 100 includes one or more sources of accounting data or general ledger data. For purposes of simplicity, the data will be referred to as “accounting data,” which will refer to general ledger data, or data that would be recorded/reported on a company's general ledger. A simple version of a system may include a single data source. Other systems may include multiple data sources, which could consist of one or more of some or all of the types of sources depicted in FIG. 1. As shown, source types may include accounting system 112, manual process 114, and enterprise resource planning system (ERP) 116. Manual process 114 refers to any type of document that is generated by manual input and includes accounting data. ERP 116 refers generally to any type of enterprise system (e.g., such as systems available from SAP AG of Walldorf, Germany, systems available from ORACLE CORPORATION of Redwood Shores, Calif., etc.). Accounting system 112 is intended to represent any other type of accounting system or data management software that does not fall under the category of a manual process or an enterprise system.

Each of data sources 112-116 provides accounting (acctg) data 118 to data workbench 102. Accounting data 118 represents data defining asset and liability account balances for a company. Note that a company may include a parent company and/or subsidiaries. The term “business entity” will refer to any type of parent and/or subsidiary. Accounting data 118 can be gathered for one or more business entities. Data workbench 102 represents one or more tools with which accounting data 118 is analyzed. The various blocks can each be considered separate tools, in which case data workbench 102 represents a “toolbox” of analysis/processing modules. Alternatively, data workbench 102 can be considered an analysis tool with various functional blocks. Other functional blocks could be added to data workbench 102. Not all functional blocks shown are necessary for an implementation of the inventive concepts described herein.

In one embodiment, data workbench 102 is provided via an application service provider (ASP) hosted environment (hosted ASP 104) accessible via a network. The environment provided by hosted ASP 104 may execute a currency exposure management system in addition to the data workbench. Hosted ASP 104 may receive information via a browser (not shown). Although described in reference to an ASP hosted environment, it will be understood that the description of various functional components can be implemented in other ways. In one embodiment, hosted ASP 104 includes a server accessible via a network, such as the Internet. Specific network interfaces are not illustrated, but are understood by those skilled in the art. Hosted ASP 104 includes hardware resources, such as processor(s), memory, network interface(s), storage components, display component(s), etc. Many hardware resources also include specific drivers or software to enable the hardware resources.

Data workbench 102 includes data collector 120, which represents one or more data gathering modules. Data collector 120 enables data workbench 102 to receive accounting data 118. In one embodiment, data collector 118 normalizes the data. That is, the data received may not have the same format if received from different systems. Normalizing could be accomplished by having operations to search for desired data, which can be extracted from received data and organized in a desired manner. In one embodiment, data collector 120 associates certain elements of data with other elements of data. For example, data belonging to the same account can be grouped together, as can data belonging to the same business entity, etc. Data may be associated via date ranges, such as specifying an effective date of data to obtain.

In general, data collector 120 will be understood to obtain “all” asset and liability account balances. In one embodiment, receiving or obtaining “all” data may refer to all data belonging to an effective date range. Thus, “all” data may refer to data of whatever business entity, and whatever account, for example, but may exclude some data from systems 112-116.

Data workbench 102 may include entity mapper 130, which represents a module that can map accounting data 118 to a particular business entity. That is, business entities may be referenced by different designations within the different systems. Part of a data normalization process may include associating all data related to a particular business entity, and identifying the business entity to which the data is related.

Data workbench 102 may include one or more report generators. As depicted, data workbench 102 may include report generators 132, 142, 152, 162, and/or 172. Some or all of the report generators could be present, depending on the implementation by the system developer. In one embodiment, report generators 132, 142, 152, 162, and/or 172 are separate functional parts of a single report generator, or instances of a report generator. In one embodiment, report generators can be enabled and/or disabled based on output reports desired from the data workbench analysis. The report generators in general provide an output report that indicates information about a particular phase of data analysis. Thus, report generator 132 represents the ability of data workbench 102 to provide output information related to the processing/analysis performed by entity mapper 130. Report generator 132 may provide a data import summary, and could indicate errors (e.g., “entity not found,” etc.) or warnings (e.g., duplicate account entry, etc.).

Filter 140 may be referred to as a functional currency (FC) filter. More specifically, filter 140 is illustrated as providing the analysis of whether FC is not equal to TC (transaction currency). That is, filter 140 eliminates account balances where the FC is equal to the TC. Account balances where FC=TC do not generate foreign currency accounting risk, since there is no change in value of the transaction over time with respect to the owning entity's functional currency. Thus, filter 140 reduces the received data set to account balances where the FC and the TC are different, and thus may be subject to foreign currency accounting risk. Report generator 142 may produce data sets of account balances where the FC is or is not equal to the TC.

Revaluation filter 150 further filters the received data set to generate a data set of account balances that are subject to revaluation. In terms understood by those familiar with the art, revaluation filter 150 filters account balances based upon account type as defined by FAS52. As used herein, FAS refers to the United States Federal Financial Accounting Standards (FAS), where FAS52 refers to Statement 52 of the accounting standards dealing with account types that should be periodically revalued. Generally, accounts that are not subject to revaluation do not contribute to the calculation of unrealized gains and losses, and can be excluded from foreign currency accounting risk analysis. Thus, revaluation filter 150 can remove account balances not subject to revaluation. Note that revaluation filter 150 is not intended to provide a complete FAS52 analysis, but allow companies to model their current revaluation processes (both systematic and manual) and review the data set created by applying the filter to assist in determining if the appropriate accounts are being revalued. Thus, report generator 152 may also provide elements of additional FAS52 analysis. Although FC filter 140 and revaluation filter 150 are shown in a particular order, there is no requirement that one filter be applied to the received data prior to the other. Thus, these blocks can be swapped in terms of order of analysis of accounting data 118.

Exclusion filter 160 provides an optional processing of accounting data 118. Exclusion filter 160 may exclude from the data set particular data, which can be identified, for example, by specific account number, account range, currency, entity, etc. Exclusion filter 160 enables data workbench 102 to exclude from analysis, for example, data with known issues, or data that is known to need special handling. Thus, the output of exclusion filter 160, or the account balances removed via exclusion filter 160 can be thought of as the “controller's to-do list.” That is, account balances removed by exclusion filter 160 have special issues to be handled by the controller of the business entity (or its parent) for which analysis is being performed. The application of exclusion filter 160 can prevent “known” errors or issues from being passed to a decision-making stage or a risk assessment/management stage of analysis. Report generator 162 can indicate the account balances removed, and/or the account balances allowed.

Data grooming module 170 provide an optional processing of accounting data 118. Data grooming 170 can enable grooming the remaining processed data to a particular formatting or standard layout. For example, the processed data may be input into data processing module 190 for additional processing. Data processing module 190 can be, for example, a system for F/X (foreign currency exchange) management as described in co-pending U.S. patent application Ser. No. TBD, entitled, “Method and System for Identifying and Managing Currency Exposure,” filed Jun. 6, 2007. There may be a particular data format that will be useful for providing to data processing module 190, which data grooming module 170 provides. Data grooming may be referred to as “preprocessing” the data for receipt by data processing module 190, and report generator 172 can generate a preprocessing report. Report generator 172 can generate any of a number of reports related to data grooming, including whether problems occurred, or whether errors or exceptions may be expected based on something in the processed data. Report generator 172 may also report on the success or failure of loading the processed data into data processing module 190. In one embodiment, data grooming module 170 nets account balances for accounts having common business entity, account, and/or currency relationships.

Report module 180 represents one or more of the report generators. Data workbench 102 generates one or more reports, which may include any or all of the reports that can be generated by each of the various report generators. Report module 180 generates one or more reports 182, which may include text output, graphical output, tables, or other form of data output.

Various operations or functions are described herein, which may be described or defined as software code, instructions, configuration, and/or data. The content may be directly executable (“object” or “executable” form), source code, or difference code (“delta” or “patch” code). The software content of the embodiments described herein may be provided via an article of manufacture with the content stored thereon, or via a method of operating a communication interface to send data via the communication interface. A machine readable medium may cause a machine to perform the functions or operations described, and includes any mechanism that provides (i.e., stores and/or transmits) information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein may be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

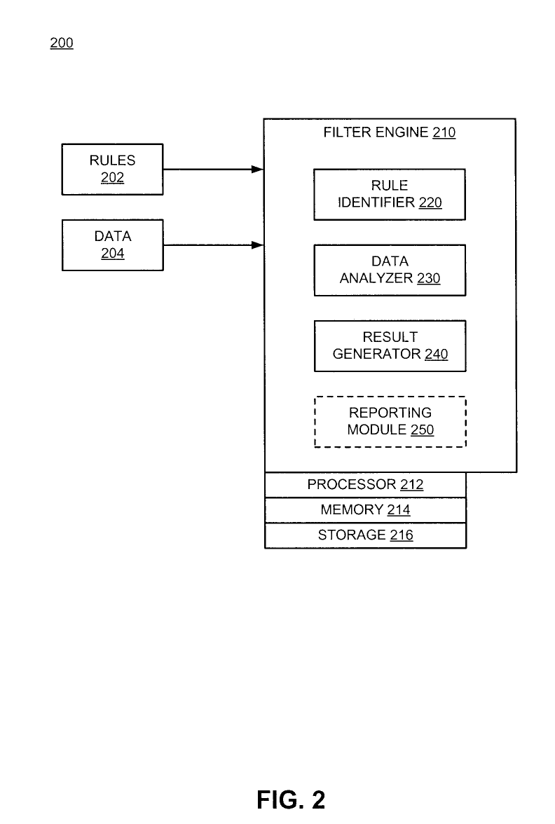

FIG. 2 is a block diagram of an embodiment of a filter engine. System 200 represents a filter or module, such as any of 130, 140, 150, 160, and/or 170 of FIG. 1. Thus, system 200 is a generic representation of various functional aspects that may be present in one or more of the filters or modules described above. In general, system 200 includes rules 202 and data 204. Rules 202 represent the functionality of the filter. For example, FC filter 140 of FIG. 1 may include a rule indicating what the functional currency of interest is. Rules 202 may also indicate a search and compare algorithm. For example, for an FC of GBP (Great British Pounds, or Pounds Sterling), rules 202 would indicate the FC and may have a rule to determine if the account balances are recorded in GBP. For account balances in GBP, such account balances can be eliminated. Data 204 represents the received data. Such received data may be the general ledger data straight from the source data systems, normalized general ledger data, or processed data from a previous stage of analysis.

System 200 includes filter engine 210, which represents the functional components of the filter. More or fewer components may exist. Some components may exist that are specific to a particular filter/module. Filter engine 210 includes a model of what data is desired and/or a model of what process is desired to be applied. That is, system 200 includes a model of the ideal analysis of received data, so that received data can be checked for correctness, as well as the processes used. Filter engine 210 can model the configuration settings of the accounting systems in place. Data that is recorded properly in a properly configured accounting systems will come out “clean” through the analysis of system 200, and thus will pass through clean through the data workbench. Improperly recorded or configured data and/or systems will produce errors during the analysis of the general ledger data.

Filter engine 210 includes rule identifier 220, which enables filter engine 210 to identify rules 202. Rules 202 may be stored in a rules database or rules structure, from which they can be retrieved. Alternatively, filter engine 210 may be a functional block that receives rules 202 as an argument when called.

Data analyzer 230 enables filter engine 210 to receive and process data 204. Data 204 would typically not be “passed” as a whole block. Rather, a pointer to a data structure representing data 204 can be received by filter engine 210, which can be received by data analyzer, which can then process each element of data in accordance with rules 202.

Result generator 240 represents one or more mechanisms through which output of filter engine 210 will be provided. For example, items of data or entries in a table can be removed from a data structure or table of data. Results can also refer to information that will be provided in a report. Each individual action of data analysis can generate an output that may be provided individually or collectively in a report.

Reporting module 250 is redundant with the report generators illustrated in FIG. 1. Reporting module 250 is illustrated to represent the fact that the reporting functionality as described in FIG. 1 may be provided by a functional block that is part of each individual filter or module. Thus, report generators may be separate from the filters or modules, but need not be separate.

System 200 is also depicted with processor 212, memory 214, and storage 216. Processor 212 represents one or more processors, which may be discrete devices, multi-core processors, central processing units (CPUs), microprocessors, microcontrollers, etc. Processor 212 enables filter engine 210 to perform processing/analysis. Storage 216 provides non-volatile storage of data and instructions. Memory 212 represents any type of memory that provides temporary storage of data and instructions. Memory 212 may include any type of random access memory (RAM), as well as read-only memory (ROM), or Flash. Thus, memory 212 may be a volatile or non-volatile memory device (i.e., it may or may not lose state when power is interrupted to the memory device). In certain computing devices, memory 212 and storage 216 may be the same device, or partitions of the same device. In one embodiment, processor 212, memory 214, and storage 216 are resources associated with a server. Accounting data is received over a network at a server, which provides the data analysis services described by the processing of data workbench 102 of FIG. 1.

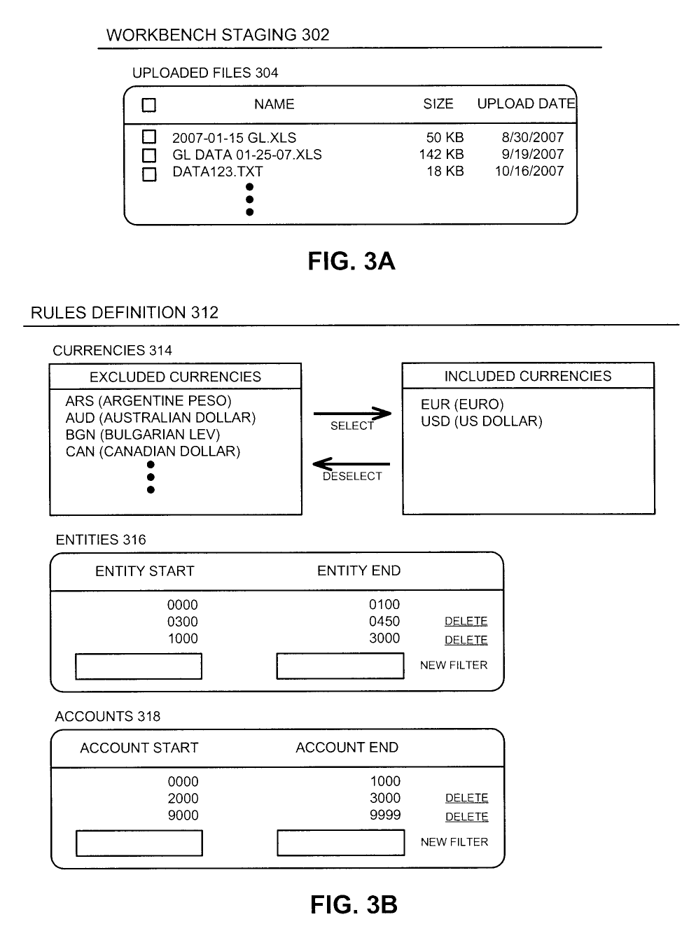

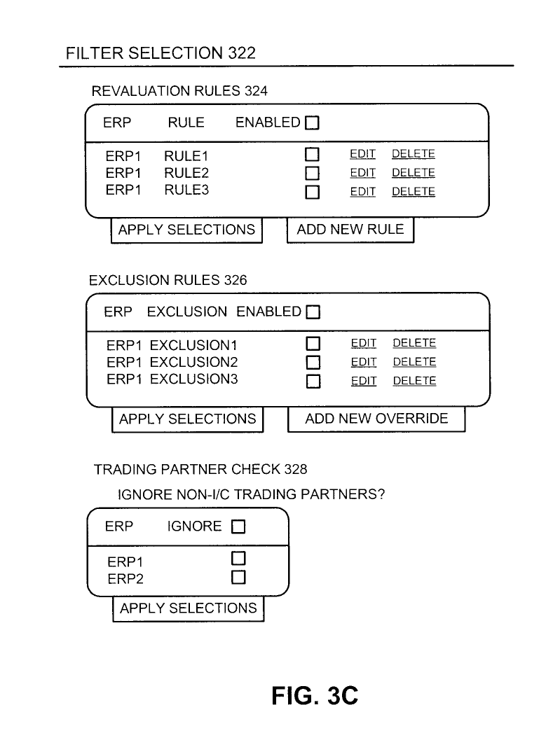

FIGS. 3A-3C are block diagrams of embodiments of user interfaces for interacting with the accounting data management tool. FIG. 3A illustrates an embodiment of a data receiving screen. Workbench staging 302 allows a user to select particular GL data files to upload for analysis. Uploaded files screen 304 illustrates a selection area with check boxes that allow a user to select which uploaded files to be analyzed. Note that workbench staging 302 assumes files have already been uploaded, and they are being selected for analysis. Files could also be uploaded and used for analysis, rather than just selecting already uploaded files. Example files are shown, such as 2007-01-15 GL.xls (which would be an EXCEL spreadsheet file compatible with MICROSOFT OFFICE products available from MICROSOFT CORPORATION of Redmond, Wash.), GL data 01-25-07.xls, and data123.txt. Information about each file can be provided, such as file size, and upload date. The number of files can vary for each business entity, but may include dozens of files. General ledger data may be referred to as all uploaded data, or only selected data to which rules and/or rules and filters will be applied.

A filter is defined by a set of one or more rules. FIG. 3B illustrates screens related to rules definition 312. Rules definition 312 may be any type of screen or interface that enables a user to select what rules to apply, to define rules, etc. Rules may be defined by specifying sets of currencies 314, entities 316, and/or accounts 318. Currencies 314 illustrate one example of a rule definition for currencies; others could be devised and employed. As shown, there may be excluded currencies and included currencies. In one embodiment, all currencies are excluded by default, with included currencies selected or deselected. Thus, in accordance with the illustration, the exposure of a business entity may be evaluated with respect to EUR (Euro) and USD (U.S. dollar), but not other currencies. Note that the exposure of EUR could be evaluated with respect to an “excluded” currency (e.g., CAN, if CAN is the functional currency of an included entity), but the exposure of CAN may not be evaluated in general for the business entity.

Entities screen 316 enables a user to select business entities to include or exclude within the general ledger data. Entities may be identified by range or filter (as illustrated), or individually. For a smaller data set, it may make sense to determine what entities exist, list them, and allow them to be individually selected. Accounts screen 318 is similar to entities screen 316. Accounts may be selected for inclusion or exclusion by range or filter, or individually. The selected entities and accounts will be used to filter data from the general ledger data, while data not related to the determined entity and account will be excluded from analysis.

A rule may also simultaneously define sets of entities, accounts, and currencies. Such a rule is evaluated by ‘anding’ the subsets together. For example, this would select an account in the Account set that is owned by an entity in the Entity set with transaction currency in the set of included currencies.

FIG. 3C illustrates screens related to filter selection 322. Filter selection 322 may be any type of screen or interface that enables a user to select and define filters. Filters may be defined by selecting subsets of rules and exclusions.

Rules screen 324 enables a user to select a set of revaluation rules to apply to the general ledger data. Generally, rules screen 324 refers to rules that will be applied to data that has passed through the FC filter of the data workbench. Rules can be enabled, edited, and/or deleted. New rules can be defined and added. Multiple rules can be applied to a data set.

Exclusion screen 326 further selects exclusion rules defining specific accounts, currencies, etc., which may be excluded in a given analysis. Such exclusions can be individually selected, edited, and/or deleted. New exclusions can be defined and applied. Multiple exclusions can be selected for a single data set.

In one embodiment, filter selection 322 includes trading partner check screen 328. In one embodiment, the data workbench will check to determine whether non-intercompany account balances include a trading partner as a part of the account balance data record, which may indicate data entry errors. Trading partner check screen 328 enables a user to select whether to ignore the trading partner in the account balance data record or not. The check can be applied or ignored individually to different systems.

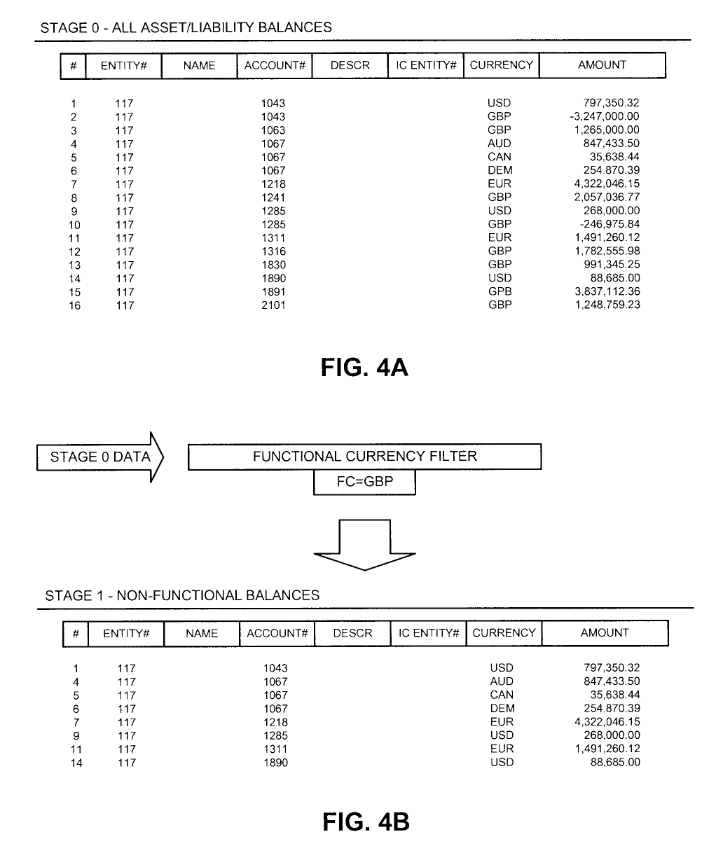

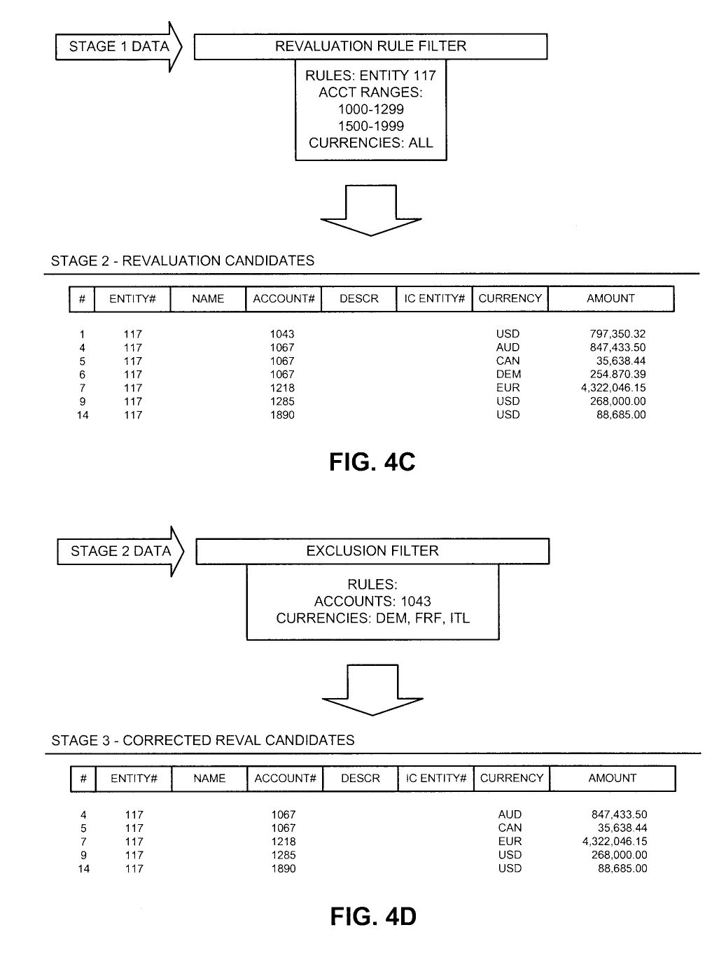

FIGS. 4A-4D are block diagram representations of an embodiment of accounting data management. FIG. 4A illustrates a beginning stage of data analysis by a data workbench as described herein. Note that the figure illustrates simulated data. The actual values of the data are not necessarily important; rather, the importance of the figures lies in the flow of data through FIGS. 4A to 4D. FIG. 4A illustrates Stage 0—All assets and liability balances. Stage 0 represents a stage where general ledger account data has been uploaded, but processing has not been performed on the data. Note the addition of the number (#) column on the far left of the Figures. The number is merely for convenience in following the flow of the diagram, and is not intended to have other significance. In Stage 0, the entity is identified (117), as well as the account number(s) of the accounts that are owned by entity 117. The transaction currency is identified, as well the value of the account in that currency. The other columns (Name, Description, and I/C entity) are not used in this example. Name refers to the name of the entity, if it has one. Description provides a location to include details related to a particular account. I/C entity # identifies the trading partner for an Intercompany transaction.

FIG. 4B illustrates the scenario of the Stage 0 data being received at the functional currency filter, where the functional currency of entity 117 is GBP. Thus, all data that was present in Stage 0 where the currency is the same as the functional currency (GBP) will be removed from the data set. Note that entries 2, 3, 8, 10, 12, 13, 15, and 16 were all listed in GBP, and so were removed from the data set. Each of these entries could be indicated on a report, and the remaining entries become the filtered or processed data set. The resulting data set is shown as Stage 1 data—non-functional account balances.

FIG. 4C illustrates the scenario where the Stage 1 data is received at a revaluation rule filter. The revaluation rule filter has rules specified, for entity 117, account ranges 1000 -1299 and 1500-1999, and for all currencies, the data should be kept. Thus, entry number 11 is removed from the data, given that its account number (1311) falls outside the range of accounts specified in the revaluation rules filter. Stage 2 data results from the application of the revaluation filter. Stage 2 data is the revaluation candidates, or those accounts that may be subject to revaluation. Accounts, such as entry 11, that are not subject to revaluation are filtered from the data set of Stage 2.

FIG. 4D illustrates the scenario Stage 2 data is received at an exclusion filter. The exclusion filter is specifically set up to exclude a particular account (1043), and remove accounts of particular currencies (DEM, FRF, and ITL). Note that account 1043 may have a known issue that prevents the data workbench user from wanting to include the account data in the F/X risk analysis. The exclusion of accounts with particular currencies could exist as recognition that the particular listed currencies (German Marks (DEM), French Francs (FRF), and Italian Lira (ITL)) are outdated currencies, replaced in each case by the Euro (EUR). Thus, the accounts may be legacy accounts that have not been cleared from the GL data for one reason or another, but may not contribute to an F/X risk that should be reported, given the outdated nature of the accounts. Thus, the exclusion filter removes entries 1 and 6. The resulting data set is represented as Stage 3 data—filtered reval (revaluation) candidates. In one embodiment, the filtered revaluation candidates represent the account balances of interest from the perspective of F/X risk management, and the Stage 3 data is the data of interest for application of currency risk routines. Note also the artificially small data set used solely for purposes of illustration. Actual data sets may contain tens of thousands of account balances and for hundreds of entities.

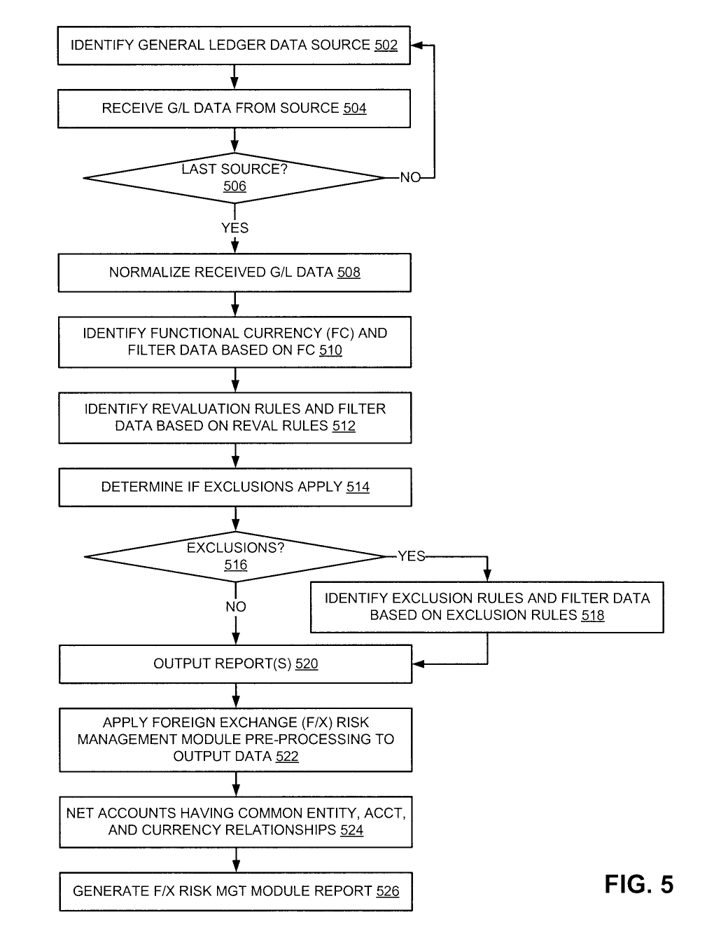

FIG. 5 is a flow diagram of an embodiment of a process for managing accounting data that contains account balances that may represent foreign currency exposure for the company. Flow diagrams as illustrated herein provide examples of sequences of various process actions. Although shown in a particular sequence or order, unless otherwise specified, the order of the actions can be modified. Thus, the illustrated implementations should be understood only as an example, and the process for the complete currency exposure dataset can be performed in a different order, and some actions may be performed in parallel. Additionally, one or more actions can be omitted in various embodiments of the invention; thus, not all actions are required in every implementation. Other process flows are possible.

A data management tool identifies a general ledger (G/L) data source, 502. The general ledger data source may be identified to the data management tool via a user interface. The general ledger data source provides at least some of the data that is evaluated for F/X risk. The data management tool receives the G/L data from the identified source, 504. If the source is not the last source of G/L data, 506, the data management tool identifies another source from which to obtain G/L data, 502. If the source is the last source to be identified and from which data is gathered, 506, the data management tool optionally normalizes the received G/L data, 508. Normalizing the data may include removing certain fields of information, rearranging the order of data, or otherwise conforming the data to a desired format or layout.

In one embodiment, the data management tool identifies the functional currency for each entity (FC) and filters the received data based on the FC, 510. The FC may be identified via the data management tool looking up the information or receiving the information with the G/L data. The data management tool also identifies one or more revaluation rules and filters the received data based on the revaluation rules, 512. As mentioned previously, a user can select rules to apply, which are obtained by the data management tool and applied to the data. The application of the revaluation rules can be performed before or after the application of the FC filter, but the filters are compounded. That is, one of the filters is applied to the received raw G/L data, and the other only filters the data that is the results set of the application of the first filter. Thus, for example, the revaluation rules are applied to the account balances that remain after the G/L data is filtered based on FC.

The data management tool determines if any exclusions apply to the processing of the G/L data, 514. If no exclusions apply, 516, the data management tool can finish its analysis and generate one or more output reports, 520. If an exclusion applies, for each exclusion, the data management system identifies the exclusion rules associated with the exclusion and filters the data based on the exclusion rules, 518. After applying the exclusion rules, which may remove more account balances from the data set to further reduce the data set, the data management tool generates one or more output reports, 520.

In one embodiment, the data management tool performs pre-processing on the data set resulting from the application of the filters (the output data) in preparation for sending the output data to a foreign exchange (F/X) risk management module, 522. Part of the pre-processing may include netting accounts having common entity, account, and currency relationships, 524. The data management tool then sends the data to the F/X risk management module and generates an F/X risk management module report, 526. The F/X risk management module report indicates exceptions encountered when the data was processed by the F/X risk management module. The F/X risk management module can then perform a risk management analysis on the data and provide options to the user to manage the risk.

Besides what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A computer implemented method for foreign currency data management comprising:
receiving a data set of general ledger data defining asset and liability account balances for a business entity;
filtering account balances from the general ledger data where the transactional currency and the functional currency of the business entity are the same, to produce a data set of non-functional currency account balances;
filtering account balances from the data set of non-functional currency account balances that are not subject to revaluation, to produce a data set of revalued account balances; and
generating a report indicating the revalued account balances.

2. The method of claim 1, wherein receiving the data set of general ledger data comprises:
receiving data sets of asset and liability account balances from multiple, different types of accounting systems.

3. The method of claim 2, wherein receiving the data sets from different types of accounting systems comprises:
receiving data sets from multiple, different types of enterprise resource planning (ERP) systems.

4. The method of claim 2, further comprising:
normalizing the data sets from the different types of accounting systems in accordance with a data format specification.

5. The method of claim 4, wherein normalizing the data sets in accordance with the data format specification further comprises:
normalizing the data sets via an ETL (extract, transform, and load) conversion.

6. The method of claim 1, wherein filtering the account balances comprises:
determining a rule to apply to a data set;
accessing the rule; and
processing the data set in accordance with the rule.

7. The method of claim 1, further comprising:
filtering account balances from the data set of revalued account balances that are excluded from consideration by an exclusion policy, to produce a data set of corrected revalued account balances.

8. The method of claim 1, further comprising:
processing the data set of revalued account balances to format the data set for introduction of the account balances into a currency exchange risk management module; and
passing the formatted data set to the currency exchange risk management module.

9. The method of claim 8, wherein processing data set comprises:
netting accounts having common entity, account, and currency relationships.

10. The method of claim 8, further comprising:
generating a preprocessing report indicating anticipated exceptions for introducing the data set into the currency exchange risk management module.

11. An article of manufacture comprising a machine readable medium having content stored thereon to provide instructions to cause a machine to perform operations including:
receiving a data set of general ledger data defining asset and liability account balances for a business entity;
filtering account balances from the general ledger data where the transactional currency and the functional currency of the business entity are the same, to produce a data set of non-functional currency account balances;
filtering account balances from the data set of non-functional currency account balances that are not subject to revaluation, to produce a data set of revalued account balances; and
generating a report indicating the revalued account balances.

12. The article of manufacture of claim 11, wherein the content to provide instructions for receiving the data set of general ledger data further comprises content to provide instructions for receiving data sets of asset and liability account balances from multiple, different types of accounting systems.

13. The article of manufacture of claim 12, the content to provide further instructions for normalizing the data sets from the different types of accounting systems in accordance with a data format specification.

14. The article of manufacture of claim 11, the content to provide further instructions for filtering account balances from the data set of revalued account balances that are excluded from consideration by an exclusion policy, to produce a data set of corrected revalued account balances.

15. The article of manufacture of claim 11, the content to provide further instructions for netting accounts having common entity, account, and currency relationships.

16. A method comprising:
accessing a communication interface; and
providing a data signal on the communication interface having data describing:
a data collection module to obtain a data set of general ledger data defining asset and liability account balances for a business entity;
a functional currency filter module to filter account balances from the general ledger data where the transactional currency and the functional currency of the business entity are the same, to produce a data set of non-functional currency account balances;
a revaluation filter module to filter account balances from the data set of non-functional currency account balances that are not subject to revaluation, to produce a data set of revalued account balances; and
a report generator to generate a report indicating the revalued account balances.

17. The method of claim 16, wherein the signal has further data describing:
the data collection module to normalize data sets of asset and liability account balances from multiple, different types of accounting systems in accordance with a specified data format.

18. The method of claim 16, wherein the signal has further data describing:
an exclusion filter to filter account balances from the data set of revalued account balances that are excluded from consideration by an exclusion policy, to produce a data set of corrected revalued account balances.

19. The method of claim 18, wherein the signal has further data describing:
the exclusion filter to net accounts having common entity, account, and currency relationships.
